(19) United States
(12) Patent Application Publication
(10) Pub. No.: US 2022/0080771 A1
(43) Pub. Date: Mar. 17, 2022

(54) NON-PNEUMATIC WHEEL WITH PRESS FIT HUB

(71) Applicants: Ryan Michael GAYLO, Greenville, SC (US); Compagnie Generale des Etablissements Michelin, Clermont-Ferrand (FR)

(72) Inventor: Ryan Michael GAYLO, Simpsonville, SC (US)

(21) Appl. No.: 17/417,262

(22) PCT Filed: Dec. 27, 2019
(86) PCT No.: PCT/US2019/068798

§ 371 Date: Jun. 22, 2021

Related U.S. Application Data
(60) Provisional application No. 62/787,019, filed on Dec. 31, 2018.

(51) Int. Cl. B60B 9/26; B60C 7/14

(52) U.S. Cl. CPC B60B 9/26; B60B 2900/523; B60C 7/146

(57) ABSTRACT

A non-pneumatic wheel (50) having a non-pneumatic tire (51) removably attached to a hub (52). The non-pneumatic wheel has an inner ring with an inner surface (70) that slips over the outer surface (80) of the hub and is retained by an interference fit. The interference fit creates an asymmetric force in an axial direction preventing separation of the hub from the tire.

### FIELD OF THE INVENTION

The subject matter of the present invention relates to non-pneumatic wheels generally and more specifically to a non-pneumatic tire and hub and method of assembling.

### BACKGROUND OF THE INVENTION

Current non-pneumatic wheels are constructed such that the compliant “tire” portion of the wheel becomes integrally attached to the non-compliant and relatively rigid hub which is mounted to the vehicle. The non-pneumatic wheels have an outer compliant band, or shear band as described in US 2018/0345718 or WO 2013/095499, a radially inner rigid hub and a plurality of flexible compliant spokes connecting the outer compliant band to the hub as described, for example in WO 2018/126157 or US 2018/0345718 or WO 2013/095499.

Of use would be a method of manufacturing a wheel such that the non-pneumatic tire may be releasable attached to a hub. Of particular use would be a method of assembly of the wheel and hub that could reduce or eliminate the use of fasteners, such as screws, bolts, nuts or rivets. Even of more particular use would be a tire having a design that would be economical to manufacture and enable reuse of the hub.

### SUMMARY OF THE INVENTION

Aspects and advantages of the invention will be set forth in part in the following description, or may be obvious from the description, or may be learned through practice of the invention.

In one exemplary embodiment, the present invention utilizes a reusable hub with a simple cylindrical mounting surface. Instead of mounting the spokes directly to the radially outer hub surface, the spokes are mounted to a simple cylinder, herein referred to as an inner cylindrical sleeve, that is then pressed onto the outside of the reusable hub. In order to ensure the sleeve is fixed to the wheel, a very slight profile is added to the outer surface of the hub and inner surface of the sleeve near the laterally outer portion of the hub and sleeve (the side facing away from the vehicle's center).

In one exemplary embodiment the profile includes surface to surface cylindrical interference fit on the hub and sleeve near both the laterally outer portion of the hub and sleeve and near the laterally inner portion of the hub and sleeve. Such an interference fit caused by a “bump” and a “groove” of the hub and sleeve respectively. The interference fit on the laterally inner portion of the hub and sleeve side ensures the two cylinders on the laterally inner portion do not separate from each other during loading (which would cause fretting), while the interference fit on the laterally outer portion ensures both limited fretting between surfaces and a method of locking the sleeve onto the wheel to prevent it from separating during usage.

In accordance with the embodiments disclosed herein the profile is such that the action of pressing the inner cylindrical sleeve onto the hub does not damage the components yet ensures enough contact pressure to keep the parts fixed. In at least one embodiment an interference of between 0.02 mm to 0.05 mm will yield high contact pressure while not exceeding the yield/fatigue strength of aluminum in the current embodiment. In an alternative embodiment, the hub and inner cylindrical sleeve have an interference fit of no greater than 0.02 mm to 0.05 mm.

In at least one embodiment, the bump is 0.1 mm high, but after seating is reduced to the same interference of 0.02 mm to 0.05 mm or alternatively no greater than 0.02 mm to 0.05 mm One aspect of the design is the smooth but high compression of the material on the laterally outer side of the wheel/sleeve bump compared to the mild/low compression on the other side, herein referred to as an “assymetric interference fit,” which causes a differential force to continually pull the sleeve back onto the wheel during hard cornering.

At least one embodiment uses aluminum for the inner cylindrical sleeve and hub, but it can be imagined that a reinforced polymer like glass reinforced nylon could be used for the sleeve and or hub in alternative embodiments. The use of different materials would likely necessitate modifications to adjust the interferences dimensions to account for relaxation and material strengths.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a perspective view of a non-pneumatic tire and hub assembled as a non-pneumatic wheel in accordance with an embodiment of the invention.

FIG. 2 provides a perspective view of the hub being pressed onto the inner cylindrical sleeve of the non-pneumatic tire.

FIG. 3 provides a sectional view taken along a radial plane of the non-pneumatic wheel shown in FIG. 1 showing a partial section of the hub, the cylindrical sleeve and inner band of the spokes of the non-pneumatic wheel.

FIG. 4 provides a sectional close up view of the hub diameter profile and the cylindrical sleeve profile of the wheel of FIG. 1.

FIG. 5 provides a sectional view in the radial plane of the hub showing an exaggerated hub diameter profile of an embodiment of the invention.

FIG. 6 provides a sectional view of the hub in the radial plane showing an exaggerated hub diameter profile of an alternative embodiment of the invention.

FIG. 7 provides a sectional view in the radial plane of the hub showing an exaggerated inner cylindrical sleeve diameter profile of an embodiment of the invention.

FIG. 8 provides a sectional view of the hub in the radial plane showing an exaggerated inner cylindrical sleeve diameter profile of an alternative embodiment of the invention.

The use of identical or similar reference numerals in different figures denotes identical or similar features.

### DETAILED DESCRIPTION OF THE INVENTION

The present invention provides a non-pneumatic tire having an inner cylindrical sleeve that is press fit onto a hub to form a non-pneumatic wheel. For purposes of describing the invention, reference now will be made in detail to embodiments and/or methods of the invention, one or more examples of which are illustrated in or with the drawings. Each example is provided by way of explanation of the invention, not limitation of the invention. In fact, it will be apparent to those skilled in the art that various modifications and variations can be made in the present invention without departing from the scope or spirit of the invention. For instance, features or steps illustrated or described as part of one embodiment, can be used with another embodiment or steps to yield a still further embodiments or methods. Thus, it is intended that the present invention covers such modifications and variations as come within the scope of the appended claims and their equivalents.

The following terms are defined as follows for this disclosure:

“Axial direction” or the letter “A” in the figures refers to a direction parallel to the axis of rotation of for example, the shear band, tire, and/or wheel as it travels along a road surface.

“Radial direction” or the letter “R” in the figures refers to a direction that is orthogonal to the axial direction and extends in the same direction as any radius that extends orthogonally from the axial direction.

“Equatorial plane” means a plane that passes perpendicular to the axis of rotation and bisects the outer tread band and/or wheel structure.

“Circumferential direction” or the letter “C” in the figures refers to a direction is orthogonal to the axial direction and orthogonal to a radial direction.

“Radial plane” means a plane that passes perpendicular to the equatorial plane and through the axis of rotation of the wheel.

“Lateral direction” or the letter “L” means a direction that is orthogonal to an equatorial plane.

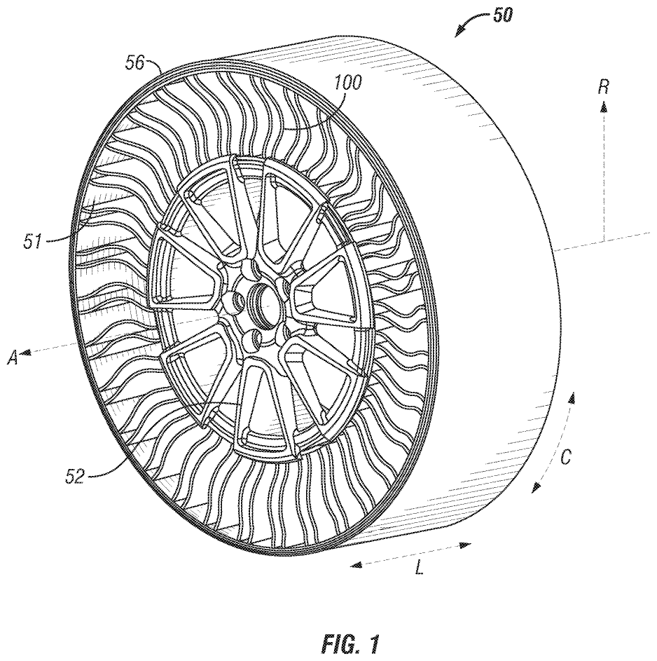

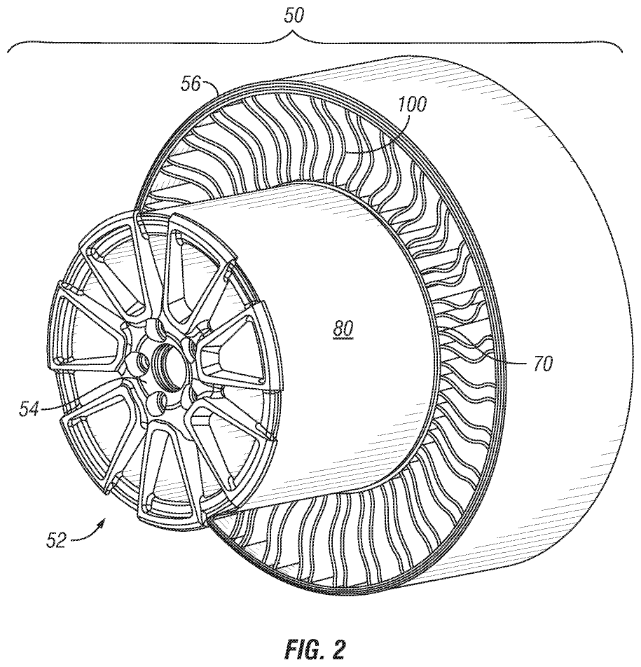

FIG. 1 provides a perspective view of a non-pneumatic tire 51 and hub 52 assembled as a non-pneumatic wheel 50 in accordance with an embodiment of the invention. In the final assembled configuration, the hub 52 mates with the inner cylindrical sleeve 70 (FIG. 2) of the non-pneumatic tire with an interference fit. The interference fit provides an asymmetrical lateral force that urges the inner cylindrical sleeve against stop surfaces of the hub and sleeve. The urging of the stop surfaces of inner cylindrical sleeve against the stop surfaces of the hub by the asymmetrical lateral force generated by the asymmetric interference fit a prevents the inner cylindrical sleeve from working itself back off the hub by creating a differential force that continuously pulls the sleeve back onto the hub during use, such as hard cornering of the vehicle. In the embodiment shown, the sleeve and hub are constructed from aluminum.

In the embodiment shown, the non-pneumatic tire possesses a compliant load supporting band 56 attached to the inner cylindrical sleeve 70 by a plurality of compliant spokes 100.

FIG. 2 provides a perspective view of the hub 52 and non-pneumatic tire 51 components of the non-pneumatic wheel 50. Assembly of the two components may be accomplished by axially pressing the hub 52 into the inner cylindrical sleeve 70 of the tire. Interference fit between the radially outer surface 80 of the hub and radially inner surface 72 of the inner cylindrical sleeve over a portion of surface area creates sufficient friction to prevent movement of the tire relative to the hub under normal loading conditions and use.

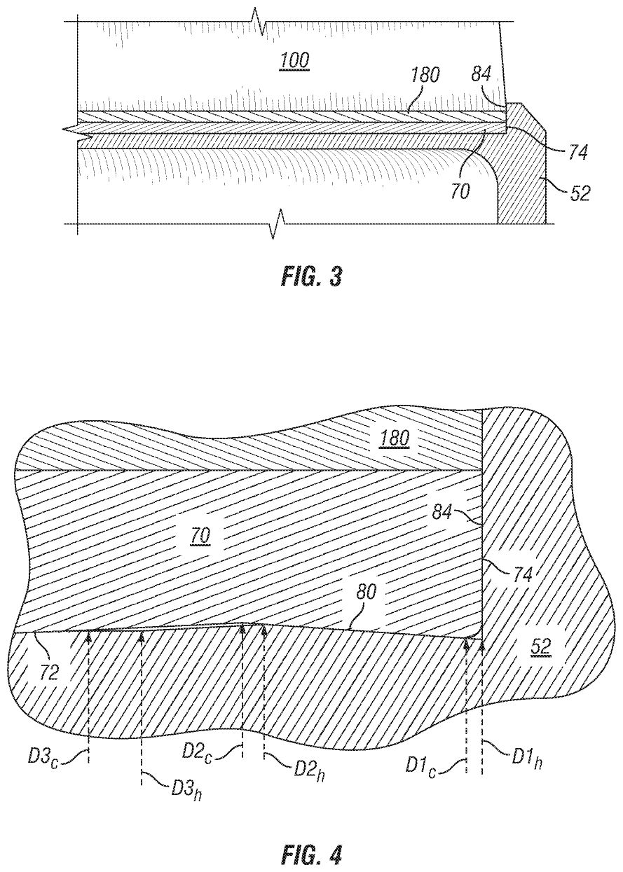

FIG. 3 provides a sectional view taken along a radial plane of the non-pneumatic wheel shown in FIG. 1 showing a partial section of the hub 52, the inner cylindrical sleeve 70 and inner band 180 of the spokes of the non-pneumatic wheel of the current embodiment. In this embodiment, the spokes are molded integrally with the inner band 180 which is bonded to the radially outer surface of the inner cylindrical sleeve 70. For example, the spokes may be cast molded using polyurethane, or alternatively comprised of plastic.

The inner cylindrical sleeve 70 is prevented from moving further onto the hub 52 by a stop surface 74 on the inner cylindrical sleeve 70 and a stop surface 84 on the hub. The stop surfaces 74, 84 are oriented in plane with the equatorial plane of the wheel. The stop surfaces prevent further movement of the two components in one lateral direction. The asymmetric interference fit prevents movement of the two components in the other lateral direction under normal operating conditions of the wheel 50.

Alternatively the spokes may be attached to the inner cylindrical sleeve 70 by other methods, such as by bonding them individually to the sleeve, or by mechanical attachment. For example, in one alternative embodiment, the spokes may possess a thickened radially inner end. The thickened radially inner end extends outward in the circumferential directions such that when the end is slipped laterally into a slot, it cannot be pulled radially out from the slot under normal loading conditions that the wheel may experience. Alternatively, the radially inner end of the spoke may be mechanically clamped to the inner band. In such embodiments, the spokes may be comprised of rubber, nylon, polyester and/or polyurethane.

FIG. 4 provides a sectional close up view of the hub diameter profile and the cylindrical sleeve diameter profile of the wheel of FIG. 1 proximate to the stop surfaces 74, 84 of the inner cylindrical sleeve 70 and hub 52. The hub diameter profile, at a position adjacent to the stop surface 84 begins at a first value D1ₕ and increases to a second value D2ₕ at a second position then decreases to a third value D3ₕ at a third position. The profile may have a linear slope between the second and third positions as shown in the current embodiment, or, alternatively, have a gradually increasing and decreasing slope, or alternatively some combination of the two.

The inner cylindrical sleeve diameter profile, at a position adjacent to the stop surface 74 begins at a first value D1_{c} and increases to a second value D2_{c} at a second position then decreases to a third value D3_{c} at a third position. The profile may have a linear slope between the second and third positions as shown in the current embodiment, or, alternatively, have a gradually increasing and decreasing slope, or alternatively some combination of the two.

As shown here, the positions of the profile diameter changes of the cylindrical sleeve are offset slightly farther away from the stop surfaces 74, 84 than the positions of the profile diameter changes of the hub creating an asymmetric interference fit. This creates a tighter interference fit along the surfaces between the first positions and the second positions of the hub and inner cylindrical sleeve than the interference fit of the surfaces between the second positions and the third positions of the hub and inner cylindrical sleeve. In the embodiment shown, there is no interference fit between the second positions and the third positions between the hub and inner cylindrical sleeve and thus a gap is shown in FIG. 4 between those surfaces. Alternatively there may be an interference fit at that location between the second and third positions, but less of an interference fit than between the hub and inner cylindrical sleeve between the first position and second position.

This asymmetric interference fit creates a lateral force urging the inner cylindrical band against the stop surface 84 of the hub. The profile diameters are such that the pressing the components together does not damage the components and yet ensures enough contact pressure to keep the parts fixed; an interference of no more than 0.02-0.05 mm will yield high contact pressure while not exceeding the yield/fatigue strength of aluminum in the current embodiment. The profile “bump” of the second position of the embodiment shown is 0.1 mm high which increases the press force, but after seating is reduced to the same interference stated before. One aspect of the embodiment is the smooth but high compression of the material on the supported side of the wheel/sleeve “bump” compared to the mild/low compression on the other side, this causes a differential force to continually pull the sleeve back onto the wheel during hard cornering. The current embodiment uses aluminum for all the components, but alternatively a reinforced polymer like glass reinforced nylon could be used for the sleeve, with modifications needed to the interferences to account for relaxation and material strengths.

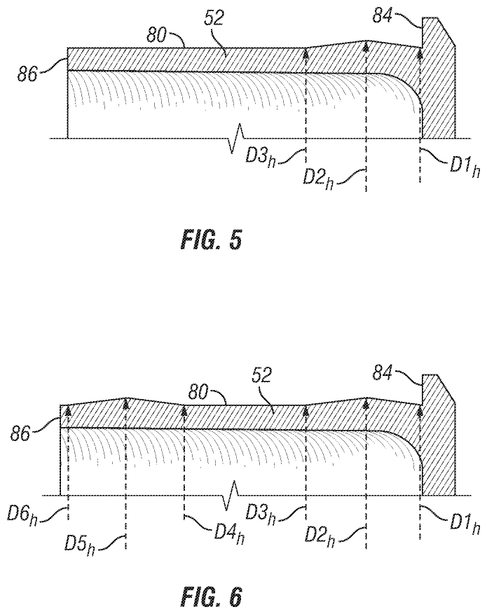

FIG. 5 provides a sectional view in the radial plane of the hub showing an exaggerated hub 52 diameter profile of an embodiment of the invention. A single circumferential “bump” created by the change in diameter of the outer surface 80 of the hub 52 as a first diameter D1ₕ increases at a first position along the axial direction to a second diameter D2ₕ at a second position along the axial direction and finally to a third diameter D3ₕ at a third location along the axial direction. In this embodiment, the diameter of the hub remains constant across the axial direction from the third position until reaching the inner edge 86 of the hub surface. Alternatively the diameter of the hub may decrease slightly across the axial direction from the third position until reaching the inner edge 86 of the hub surface. It should be understood that small fillets or rounds may be present at the inner edge 86, or at the edge between the radially outer surface 80 of the hub and the hub stop surface 84.

FIG. 6 provides a sectional view of the hub in the radial plane showing an exaggerated hub diameter profile of an alternative embodiment of the invention. Two “bumps” are created by the change in diameter of the outer surface 80 of the hub 52 as a first diameter D1ₕ increases at a first position along the axial direction to a second diameter D2ₕ at a second position along the axial direction and finally to a third diameter D3ₕ at a third location along the axial direction creating a first bump. The second bump is created by the change in diameter of the outer surface 80 of the hub 52 as a fourth diameter D4ₕ increases at a fourth position along the axial direction to a fifth diameter D5ₕ at a fifth position along the axial direction and finally to a sixth diameter D6ₕ at a sixth location along the axial direction creating a second bump. In this embodiment, the diameter of the hub remains constant across the axial direction from the third position until the fourth position. Alternatively the diameter of the hub may decrease slightly across the axial direction from the third position to the fourth position. Such a decrease in diameter would aid assembly by decreasing the interference fit until the components are almost in their final positions as the inner cylindrical sleeve is pressed toward the hub stop surface 84. It should be understood that small fillets or rounds may be present at the inner edge 86, or at the corner between the radially outer surface 80 of the hub and the hub stop surface 84.

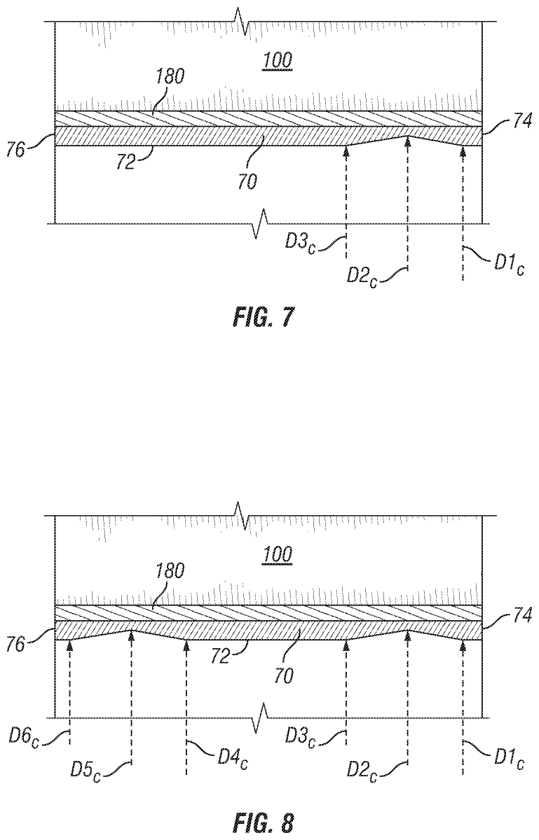

FIG. 7 provides a sectional view in the radial plane of the hub showing an exaggerated inner cylindrical sleeve diameter profile of an embodiment of the invention. A single circumferential “groove” created by the change in diameter of the radially inner surface 72 of the inner cylindrical sleeve 70 as a first diameter D1_{c} increases at a first position along the axial direction to a second diameter D2_{c} at a second position along the axial direction and finally to a third diameter D3_{c} at a third location along the axial direction. In this embodiment, the diameter of the inner cylindrical sleeve 70 remains constant across the axial direction from the third position until reaching the inner edge 76 of the inner cylindrical sleeve 70 surface. Alternatively the diameter of the inner cylindrical may decrease slightly across the axial direction from the third position until reaching the inner edge 76 of the inner cylindrical surface. It should be understood that small fillets or rounds may be present at the inner edge 76, or at the edge between the radially inner surface 72 of the inner cylindrical sleeve and the inner cylindrical sleeve stop surface 74.

FIG. 8 provides a sectional view of the hub in the radial plane showing an exaggerated inner cylindrical sleeve diameter profile of an alternative embodiment of the invention. Two circumferential “grooves” are created by the change in diameter of the radially inner surface 72 of the inner cylindrical sleeve 70 as a first diameter D1_{c} increases at a first position along the axial direction to a second diameter D2_{c} at a second position along the axial direction and finally to a third diameter D3_{c} at a third location along the axial direction creating a first groove. The second groove is created by the change in diameter of the radially inner surface 72 of the inner cylindrical sleeve 70 as a fourth diameter D4_{c} increases at a fourth position along the axial direction to a fifth diameter D5_{c} at a fifth position along the axial direction and finally to a sixth diameter D6_{c} at a sixth location along the axial direction creating a second groove. In this embodiment, the diameter of the inner cylindrical sleeve remains constant across the axial direction from the third position until the fourth position. Alternatively the diameter of the inner cylindrical sleeve 70 may decrease slightly across the axial direction from the third position to the fourth position. Such a decrease in diameter, when paired with a complimentary decrease in diameter of the hub 52 radially outer surface, would aid assembly by decreasing the interference fit until the components are almost in their final positions as the inner cylindrical sleeve stop surface 74 is pressed toward the hub stop surface 84. It should be understood that small fillets or rounds may be present at the inner edge 86, or at the corner between the radially outer surface 80 of the hub and the hub stop surface 84.

The invention and embodiments shown herein can be readily reproduced using normal manufacturing methods and well known dimensioning and tolerancing standards. One skilled in the art of product design, particularly wheels, can readilly design these parts upon reading an understanding the description contained herein. Materials used for construction of the hub and inner cylindrical sleeve may include automotive grade aluminum or steel materials and utilization of normal 3/4/5 axis machining technologies to manufacture the parts. These are all readily available to companies currently active in the non-pneumatic tire domain. Alternatively the inner cylindrical sleeve and/or hub could be made using a reinforced polymer material like chopped glass reinforced nylon, discrete fiber reinforced PU/nylon, reinforced rubber, or other commonly known reinforced composite structures.

Once the inner cylindrical sleeve 70 is pressed onto the hub 52, the asymmetric interference fit holds the components together under normal wheel loading conditions. If the non-pneumatic wheel wears out or otherwise needs replacement, the inner cylindrical sleeve 70 and attached tire may be pressed off the hub 52 for replacement with a new non-pneumatic tire onto the hub.

It should be understood that other web element configurations and geometries may be used within the scope of the invention, including web elements which are interconnected such as where they may form a honeycomb or other pattern.

Selected combinations of aspects of the disclosed technology correspond to a plurality of different embodiments of the present invention. It should be noted that each of the exemplary embodiments presented and discussed herein should not insinuate limitations of the present subject matter. Features or steps illustrated or described as part of one embodiment may be used in combination with aspects of another embodiment to yield yet further embodiments. Additionally, certain features may be interchanged with similar devices or features not expressly mentioned which perform the same or similar function.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm” Also, the dimensions and values disclosed herein are not limited to a specified unit of measurement. For example, dimensions expressed in English units are understood to include equivalent dimensions in metric and other units (e.g., a dimension disclosed as “1 inch” is intended to mean an equivalent dimension of “2.5 cm”).

As used herein, the term “method” or “process” refers to one or more steps that may be performed in other ordering than shown without departing from the scope of the presently disclosed invention. As used herein, the term “method” or “process” may include one or more steps performed at least by one electronic or computer-based apparatus. Any sequence of steps is exemplary and is not intended to limit methods described herein to any particular sequence, nor is it intended to preclude adding steps, omitting steps, repeating steps, or performing steps simultaneously. As used herein, the term “method” or “process” may include one or more steps performed at least by one electronic or computer-based apparatus having a processor for executing instructions that carry out the steps.

The terms “a,” “an,” and the singular forms of words shall be taken to include the plural form of the same words, such that the terms mean that one or more of something is provided. The terms “at least one” and “one or more” are used interchangeably. Ranges that are described as being “between a and b” are inclusive of the values for “a” and “b.”

Every document cited herein, including any cross-referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

What is claimed is:

1. A non-pneumatic wheel defining radial, axial and circumferential directions, the wheel comprising:
an outer non-pneumatic tire and a hub;
the tire comprising:
an inner cylindrical sleeve having a radially inward facing surface having a sleeve diameter sloped profile that increases from a first value at a first location along the axial direction to a second value at a second location along the axial direction then decreases to a third value at a third location along the axial direction along the axial width of the sleeve;
an outer compliant load supporting band; and
a plurality of flexible spokes connecting the inner sleeve to the outer compliant load supporting band;
the hub comprising:
a plurality of apertures for receiving fasteners for mounting to a vehicle;
a radially outward facing cylindrical hub surface having a hub diameter profile that varies across the axial width of the hub;
wherein the radially inward facing cylindrical sleeve surface mates with the radially outward facing cylindrical hub surface with an asymmetric interference fit.

2. The non-pneumatic wheel of claim 1 further comprising an axial stop.

3. The non-pneumatic wheel of claim 1 wherein said hub diameter profile increases from a first value at a first location along the axial direction to a second value at a second location along the axial direction then decreases to a third value at a third location along the axial direction.

4. (canceled)

5. The non-pneumatic wheel of claim 1 wherein a greater interference fit occurs between the second location of said hub and the third location of said hub and a smaller or no interference fit occurs between the first location of said hub and the second location of said hub.

6. The non-pneumatic wheel of claim 5 further comprising an axial stop located on the lateral side of the wheel closer to the third location than the first or second location.

7. The non-pneumatic wheel of claim 2 wherein the axial stop is comprised of an axially oriented surface extending from the hub.

8. The non-pneumatic wheel of claim 7 wherein the axial stop prevents an axial surface of the inner cylindrical sleeve of the tire from sliding any further in an axial direction past the axial stop.

9. The non-pneumatic wheel of claim 1 wherein the sleeve diameter transitions from the first value to the second value at a constant rate thereby having a linear slope when viewed in an axial cross section.

10. The non-pneumatic wheel of claim 1 wherein the sleeve diameter transitions from a first value to a second value at a variable rate, thereby having a non-linear slope when viewed in an axial cross section.

11. A non-pneumatic tire defining radial, axial and circumferential directions, configured to mate with a hub, the tire comprising:
an inner cylindrical sleeve having a radially inward facing surface having a sleeve diameter sloped profile that increases from a first value at a first location along the axial direction to a second value at a second location along the axial direction then decreases to a third value at a third location along the axial direction along the axial width of the sleeve;
an outer compliant load supporting band; and
a plurality of flexible spokes connecting the inner sleeve to the outer compliant load supporting band.

12. The tire of claim 11 further comprising the hub to form a wheel, the hub comprising:
a plurality of apertures for receiving fasteners for mounting to a vehicle;
a radially outward facing cylindrical hub surface having a hub diameter profile that varies across the axial width of the hub;
wherein the radially inward facing cylindrical sleeve surface mates with the radially outward facing cylindrical hub surface with an asymmetric interference fit.

13. The non-pneumatic wheel of claim 12 further comprising an axial stop.

14. The non-pneumatic wheel of claim 12 wherein said hub diameter profile increases from a first value at a first location along the axial direction to a second value at a second location along the axial direction then decreases to a third value at a third location along the axial direction.

15. The non-pneumatic wheel of claim 13 wherein the axial stop is comprised of an axially oriented surface extending from the hub.

16. The non-pneumatic wheel of claim 15 wherein the axial stop prevents an axial surface of the inner cylindrical sleeve of the tire from sliding any further in an axial direction past the axial stop.

17. The non-pneumatic wheel of claim 11 wherein the sleeve diameter transitions from the first value to the second value at a constant rate thereby having a linear slope.

18. The non-pneumatic wheel of claim 11 wherein the sleeve diameter transitions from a first value to a second value at a variable rate, thereby having a non-linear slope.

19. A non-pneumatic wheel defining radial, axial and circumferential directions, the wheel comprising:
an outer non-pneumatic tire and a hub;
the tire comprising:
an inner cylindrical sleeve having a radially inward facing surface having a sleeve diameter sloped profile that increases from a first value at a first location along the axial direction to a second value at a second location along the axial direction then decreases to a third value at a third location along the axial direction along the axial width of the sleeve then increases to a fourth value at a fourth location along the axial direction, then decreases to a fifth value at a fifth location along the axial direction;
an outer compliant load supporting band; and
a plurality of flexible spokes connecting the inner sleeve to the outer compliant load supporting band;
the hub comprising:
a plurality of apertures for receiving fasteners for mounting to a vehicle;
a radially outward facing cylindrical hub surface having a hub diameter profile that varies across the axial width of the hub;
wherein the radially inward facing cylindrical sleeve surface mates with the radially outward facing cylindrical hub surface with an asymmetric interference fit.

20. The non-pneumatic wheel of claim 19 wherein the sleeve diameter transitions from the first value to the second value at a constant rate thereby having a linear slope.

21. The non-pneumatic wheel of claim 19 wherein the sleeve diameter transitions from a first value to a second value at a variable rate, thereby having a non-linear slope.
